(19) United States
(12) Patent Application Publication
(10) Pub. No.: US 2024/0349108 A1
(43) Pub. Date: Oct. 17, 2024

(54) SYSTEMS AND METHODS FOR ALIGNMENT OF RADIO ACCESS NETWORK (RAN) VISIBLE QUALITY OF EXPERIENCE (QOE) AND MINIMIZED DRIVE TEST (MDT)

(71) Applicant: ZTE Corporation, Shenzhen (CN)

(72) Inventors: Man ZHANG, Shenzhen (CN); Yin GAO, Shenzhen (CN); Dapeng LI, Shenzhen (CN); Zhuang LIU, Shenzhen (CN); Yansheng LIU, Shenzhen (CN)

(73) Assignee: ZTE Corporation, Shenzhen (CN)

(21) Appl. No.: 18/750,059

(22) Filed: Jun. 21, 2024

Related U.S. Application Data
(63) Continuation of application No. PCT/CN2022/107471, filed on Jul. 22, 2022.

(51) Int. Cl. H04W 24/10; H04W 28/16

(52) U.S. Cl. CPC H04W 24/10; H04W 28/16

(57) ABSTRACT

Presented are systems and methods for alignment of radio access network (RAN) visible quality of experience (QoE) and minimized drive test (MDT). A first network node of a radio access network (RAN) may determine that the first network node is to perform alignment of at least one minimized drive test (MDT) measurement and at least one quality of experience (QoE) measurement that is to be utilized by the RAN, for QoE analysis. The first network node may perform the alignment for the QoE analysis.

### CROSS-REFERENCE TO RELATED APPLICATION

This application claims the benefit of priority under 35 U.S.C. § 120 as a continuation of International Patent Application No. PCT/CN2022/107471, filed on Jul. 22, 2022, the disclosure of which is incorporated herein by reference in its entirety.

### TECHNICAL FIELD

The disclosure relates generally to wireless communications, including but not limited to systems and methods for alignment of radio access network (RAN) visible quality of experience (QoE) and minimized drive test (MDT).

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based, and some being hardware based, so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments (e.g., including combining features from various disclosed examples, embodiments and/or implementations) can be made while remaining within the scope of this disclosure.

At least one aspect is directed to a system, method, apparatus, or a computer-readable medium of the following. A first network node (e.g., a master node (MN) or a secondary node (SN)) of a radio access network (RAN) may determine that the first network node is to perform alignment of at least one minimized drive test (MDT) measurement and at least one quality of experience (QoE) measurement that is to be utilized by the RAN (e.g., a RAN visible QoE configuration), for QoE analysis. The first network node may perform the alignment for the QoE analysis.

In some embodiments, a wireless communication device may generate a report according to the at least one QoE measurement. The report may comprise at least one of: a trace identifier (id) associated with the at least one MDT measurement, an id of the at least one QoE measurement, an id of at least one QoE measurement to be utilized by an entity other than the RAN (e.g., QoE measurement that can be invisible to (or not for utilization by) the RAN), an indication of at least one QoE metrics to include in the at least one QoE measurement, an indication of at least one QoE values to be determined from the at least one QoE metrics, an indication of one or more nodes (e.g., a MN or a SN) of the RAN that is to utilize the at least one QoE measurement, time stamp information of the at least one QoE measurement, quality of service (QOS) flow information of the at least one QoE measurement, or data radio bearer (DRB) list information of the at least one QoE measurement.

In some embodiments, the first network node (e.g., a MN or a SN) may receive a report of the at least one MDT measurement from a second network node of the RAN. The first network node may receive a report of the at least one QoE measurement from a second network node of the RAN. The second network node may receive an indication that the first network node is to perform the alignment from a core network (CN) or an operations, administration and maintenance (OAM) function. The second network node may send the indication to the first network node. The first network node may determine that the first network node is to perform the alignment for the QoE analysis according to the indication.

In some embodiments, the first network node may receive an indication that the first network node is to perform the alignment from a core network (CN) or an operations, administration and maintenance (OAM) function. The first network node may send the indication to the second network node. The second network node may determine that the first network node is to perform the alignment for the QoE analysis according to the indication.

In some embodiments, the first network node may send a message via XnAP, requesting or indicating that the first network node is to perform the alignment to a second network node of the RAN. In response to the message, the second network node may send an acknowledgment or confirmation to the first network node (via an XnAP message). In certain embodiments, the first network node may comprise a master node (MN); and the second network node may comprise a secondary node (SN). In certain embodiments, the first network node may comprise a secondary node (SN); and the second network node may comprise a master node (MN).

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates a sequence diagram for alignment of radio access network (RAN) visible quality of experience (QoE) measurements and minimized drive test (MDT) measurements, in accordance with some embodiments of the present disclosure;

FIG. 4 illustrates a sequence diagram for alignment of radio access network (RAN) visible quality of experience (QoE) measurements and minimized drive test (MDT) measurements, in accordance with some embodiments of the present disclosure;

FIG. 5 illustrates a sequence diagram for alignment of radio access network (RAN) visible quality of experience (QoE) measurements and minimized drive test (MDT) measurements, in accordance with some embodiments of the present disclosure;

FIG. 6 illustrates a sequence diagram for alignment of radio access network (RAN) visible quality of experience (QoE) measurements and minimized drive test (MDT) measurements, in accordance with some embodiments of the present disclosure; and

FIG. 7 illustrates a flow diagram for alignment of radio access network (RAN) visible quality of experience (QoE) measurements and minimized drive test (MDT) measurements, in accordance with an embodiment of the present disclosure.

### DETAILED DESCRIPTION

### 1. Mobile Communication Technology and Environment

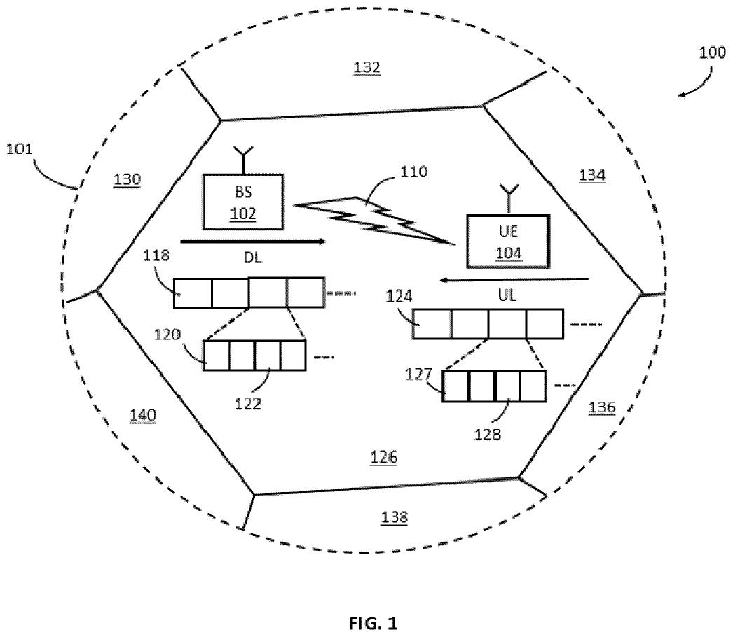

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

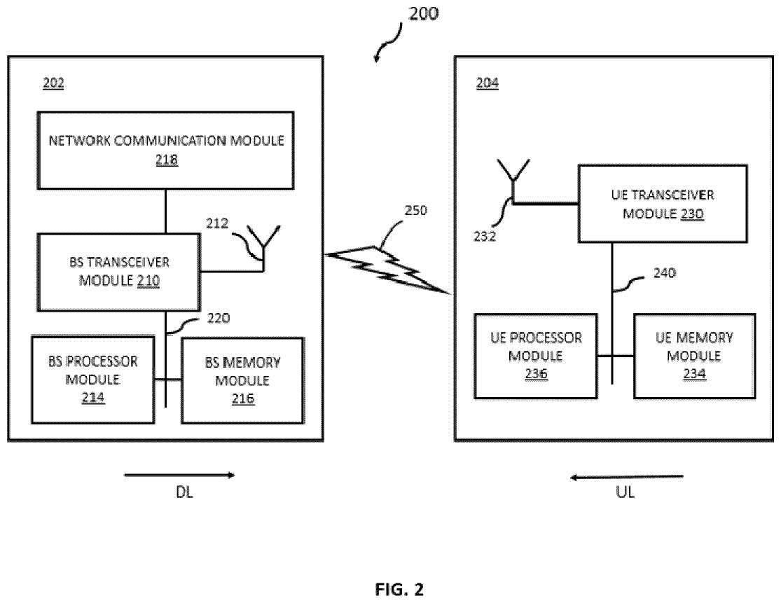

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (cNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for Alignment of Radio Access Network (RAN) Visible Quality of Experience (QoE) Measurements and Minimized Drive Test (MDT) Measurements

Quality of Experience (QoE) measurements can be configured to collect measurement results of certain service types in a user equipment (UE) application layer. A report of the QoE measurements can be transparent/invisible to a radio access network (RAN) node. QoE measurements may be transferred to a measurement collection entity (MCE) for analysis. MDT reports can be used for an alignment with QoE measurements in the collection entity to help with QoE analysis.

The RAN visible QoE measurement can be configured if a QoE measurement is activated. However, the alignment of RAN visible QoE and MDT measurements/reports/results/metrics may not been solved. This invention provides a technique to achieve an alignment of a RAN visible QoE and a MDT measurements/reports/results/metrics in a dual connectivity architecture and/or a split architecture.

New radio (NR) QoE measurement collection (QMC) function can be activated by operations, administration and maintenance (OAM) via a separate QMC framework. For a signaling-based QoE, the QMC configuration for a specific UE can be sent from the OAM to a core network (CN), and the CN may send the QMC configuration to the RAN node via a UE-associated signaling (e.g., a NGAP/XnAP/F1AP message). For a management-based QoE, the OAM may send the QMC configuration to the RAN node. The RAN node may select UEs which satisfies the condition for the QoE measurement, and may send the QMC configuration to the UEs.

For a QoE reporting in standalone architecture, a UE application layer may collect QoE metrics, and may send collected data according to the QoE metrics to a UE AS layer via an attention (AT) command. The UE AS layer may send the collected data (e.g., QoE reports) to the RAN node. After the RAN node receives the QoE reports, the RAN node may transfer the received QoE reports to a measurement collection entity (MCE). The MCE can be an entity which collects QoE measurement reports and performs analysis for optimization. The QoE reports can be transparent/invisible to the RAN node, which means the RAN node may not read the contents in the QoE reports.

Minimized drive test (MDT) measurements can be collected and used for QoE analysis, which is called MDT-QoE alignment. If the QMC configuration includes a trace identifier (ID) of the MDT measurement, the RAN node may transfer the corresponding MDT reports to the MCE for alignment with the QoE. Time stamp information and trace ID may be sent together for MCE to make a correlation with MDT and QoE reports in time scale. After the QoE measurement starts in the UE APP layer, the UE may send a QoE start indication to the RAN node. After the RAN node receives the QoE measurement start indication, the RAN node may activate the MDT configuration.

A RAN visible QoE can be a sub-feature of QoE. The RAN can configure the RAN visible QoE based on its own requirements when a QoE measurement is activated. The RAN visible QoE may be associated with the QoE measurement by an id of the QoE measurement. The UE may collect RAN visible QoE measurement results, and may report the measurement results to the RAN node. The RAN node may use the measurement results for network optimizations. In centralized unit (CU)-distributed unit (DU) split architecture, the CU may transfer the RAN visible QoE measurement results to the DU via a F1AP message.

In a dual connectivity (DC), the UE can be connected to two RAN nodes. One of the RAN nodes may act as a master node (MN), and another one of the RAN nodes may act as a secondary node (SN). Both the MN and the SN can be configured with minimization of drive tests (MDT), and can collect MDT reports. The MDT can be activated via a trace function. The MDT reports can be sent to a trance collection entity (TCE). The QoE measurement reports can be sent to a measurement collection entity (MCE).

### Implementation Example 1: MN Performs an Alignment of RAN Visible QoE and MDT

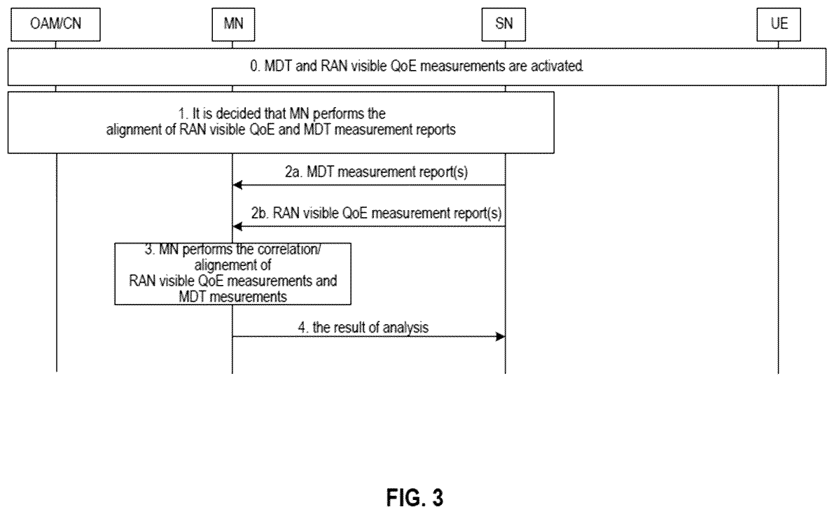

FIG. 3 illustrates a sequence diagram for alignment of radio access network (RAN) visible quality of experience (QoE) and minimized drive test (MDT) measurements/reports/results.

In step 0, MDT measurement(s) and RAN visible QoE measurement(s) can be activated. The MDT and RAN visible QoE may not be necessarily to be activated simultaneously. The MDT may be activated before the RAN visible QoE, later than the RAN visible QoE, or at the same time with the RAN visible QoE. The MN/SN may collect MDT measurement report(s) and RAN visible QoE measurement report(s) based on a MDT configuration and a RAN visible QoE measurement configuration. The RAN visible QoE reports can be reported from a UE. A QoE may need/require to gather numerous parameters (e.g., encoding, transport, content, type of terminal, network, services infrastructure, media encoding, and/or user's expectations). QoE can be an important function for design of systems and engineering processes. The information in the RAN visible QoE report may include at least one of: a trace identifier (id) associated with the at least one MDT measurement, an id of the at least one QoE measurement, an id of at least one QoE measurement to be utilized by an entity other than the RAN (e.g., QoE measurement that can be invisible to (or not for utilization by) the RAN), at least one QoE metrics to include in the at least one QoE measurement, at least one QoE values to be determined from the at least one QoE metrics, an indication of one or more nodes (e.g., a MN or a SN) of the RAN that is to utilize the at least one QoE measurement, time stamp information of the at least one QoE measurement, quality of service (QOS) flow information of the at least one QoE measurement, or data radio bearer (DRB) list information of the at least one QoE measurement. The time stamp information of the at least one QoE measurement may include values that contain both date and time parts (e.g., yyyy-mm-dd hh:mm:ss).

In step 1, a network node (e.g., a OAM/CN, a MN, a SN, a CU, or a DU) may decide/determine that the MN performs the alignment of RAN visible QoE and MDT measurements/reports/results. Procedures about how a decision/determination can be made is described in implementation example 3.

In step 2a, if there is MDT report(s) collected in the SN, the SN may send the MDT measurement report(s) to the MN via an Xn application protocol (XnAP) message.

In step 2b, if there is RAN visible QoE measurement report(s) collected in the SN, the SN may send the RAN visible QoE measurement report(s) to the MN via an XnAP message.

In step 3, the MN may perform a correlation of MDT reports and RAN visible QoE measurement reports according to the measurement id information and/or the time stamp information in the reports. The analysis results can be used to assist with network optimization.

In step 4, the MN may send the analysis results to the SN to help with the network optimization in the SN.

### Implementation Example 2: SN Performs an Alignment of RAN Visible QoE and MDT

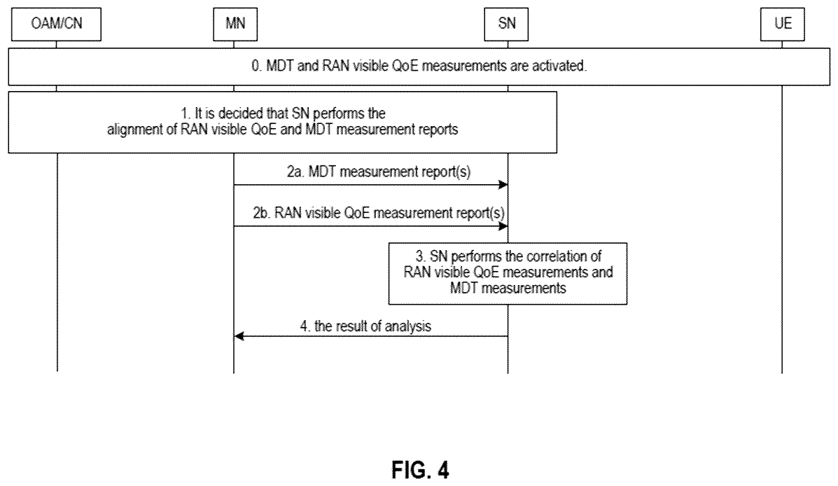

FIG. 4 illustrates a sequence diagram for alignment of radio access network (RAN) visible quality of experience (QoE) and minimized drive test (MDT) measurements/reports/results.

In step 0, MDT measurement(s) and RAN visible QoE measurement(s) can be activated. The MDT and RAN visible QoE measurements may not be necessarily to be activated simultaneously. The MDT measurements may be activated before the RAN visible QoE measurements, later than the RAN visible QoE measurements, or at the same time with the RAN visible QoE measurements. The MN/SN may collect MDT measurement report(s) and RAN visible QoE measurement report(s) based on a MDT configuration and a RAN visible QoE measurement configuration. The RAN visible QoE reports can be reported from a UE. A QoE measurement/determination may involve gathering numerous parameters (e.g., encoding, transport, content, type of terminal, network, services infrastructure, media encoding, and/or user's expectations). QoE can be an important metric for design of systems and engineering processes. The information in the RAN visible QoE report may include at least one of: a trace identifier (id) associated with the at least one MDT measurement, an id of the at least one QoE measurement, an id of at least one QoE measurement to be utilized by an entity other than the RAN (e.g., QoE measurement that can be invisible to (or not for utilization by) the RAN), at least one QoE metrics to include in the at least one QoE measurement, at least one QoE values to be determined from the at least one QoE metrics, an indication of one or more nodes (e.g., a MN or a SN) of the RAN that is to utilize the at least one QoE measurement, time stamp information of the at least one QoE measurement, quality of service (QOS) flow information of the at least one QoE measurement, or data radio bearer (DRB) list information of the at least one QoE measurement. The time stamp information of the at least one QoE measurement may include values that contain both date and time parts (e.g., yyyy-mm-dd hh:mm:ss).

In step 1, a network node (e.g., a OAM/CN, a MN, a SN, a CU, or a DU) may decide/determine that the SN performs the alignment of RAN visible QoE and MDT measurements/reports/results. Procedures about how a decision/determination can be made is described in implementation example 3.

In step 2a, if there is MDT report(s) collected in the MN, the MN may send the MDT measurement report(s) to the SN via an XnAP message.

In step 2b, if there is RAN visible QoE measurement report(s) collected in the MN, the MN may send the RAN visible QoE measurement report(s) to the SN via an XnAP message.

In step 3, the SN may perform a correlation of MDT reports/results/measurement/metrics and RAN visible QoE measurements/reports/results according to the measurement id information and the time stamp information in the reports. The analysis results can be used to assist with a network optimization.

In step 4, the SN may send the analysis results to the MN to help with the network optimization in the MN.

### Implementation Example 3: The Decision of which Node to Perform the Alignment of RAN Visible QoE and MDT

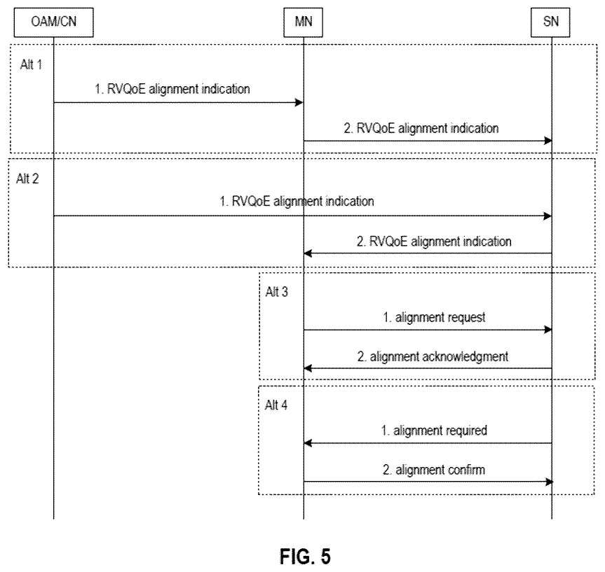

FIG. 5 illustrates a sequence diagram for alignment of radio access network (RAN) visible quality of experience (QoE) and minimized drive test (MDT) measurements/reports/results.

### Alternative 1

In step 1, the OAM or CN may send the RAN visible QoE alignment indication to the MN. The indication can be used to indicate which node is to perform the alignment of RAN visible QoE and MDT measurements/reports/results. The format of the indication can be enumerated (MN, SN, . . . ). The RAN visible QoE alignment indication can be included inside the QoE measurement configuration.

In step 2, after the MN receives the RAN visible QoE alignment indication, the MN may transfer the indication to the SN via an XnAP message (e.g., S-node modification request). If the indication is to let the MN perform the alignment of RAN visible QoE measurements/results and MDT measurements/results, the SN may send collected MDT reports and RAN visible QoE results to the MN. If the indication is to let the SN perform the alignment of RAN visible QoE and MDT, the MN may send collected MDT reports and RAN visible QoE results to the SN.

### Alternative 2

In step 1, the OAM or CN may send the RAN visible QoE alignment indication to the SN. The indication can be used to indicate which node is to perform the alignment of RAN visible QoE and MDT measurements/reports/results. The format of the indication can be enumerated (MN, SN, . . . ). The RAN visible QoE alignment indication can be included inside the QoE measurement configuration.

In step 2, after the SN receives the RAN visible QoE alignment indication, the SN may transfer the indication to the MN via an XnAP message (e.g., S-node modification request). If the indication is to let the SN perform the alignment of RAN visible QoE measurements/reports/results and MDT measurements/reports/results, the MN may send collected MDT reports and RAN visible QoE results to the SN. If the indication is to let the MN perform the alignment of RAN visible QoE measurements/reports/results and MDT measurements/reports/results, the SN may send collected MDT reports and RAN visible QoE results to the MN.

### Alternative 3

In step 1, the MN may send an alignment request to the SN via an XnAP message (e.g., S-node modification request) to notify the SN that the MN is to perform the alignment of RAN visible QoE and MDT measurements/reports/results.

In step 2, after the SN receives the alignment request from the MN, the SN may send an alignment acknowledgement to the MN via an XnAP message (e.g., S-node modification acknowledgement). If there are collected MDT reports or RAN visible QoE reports in the SN, the SN may send the reports to the MN via an XnAP, as described in implementation example 1.

### Alternative 4

In step 1, the SN may send an alignment request to the MN via an XnAP message (e.g., S-node modification request) to notify the MN that the SN is to perform the alignment of RAN visible QoE measurements/results and MDT measurements/results.

In step 2, after the MN receives the alignment request from the SN, the MN may send an alignment confirmation to the SN via an XnAP message (e.g., S-node modification confirmation). If there are collected MDT reports or RAN visible QoE reports in the MN, the MN may send the reports to the SN via an XnAP, as described in implementation example 2.

### Implementation Example 4: The Alignment of RAN Visible QoE and MDT in a Split Architecture

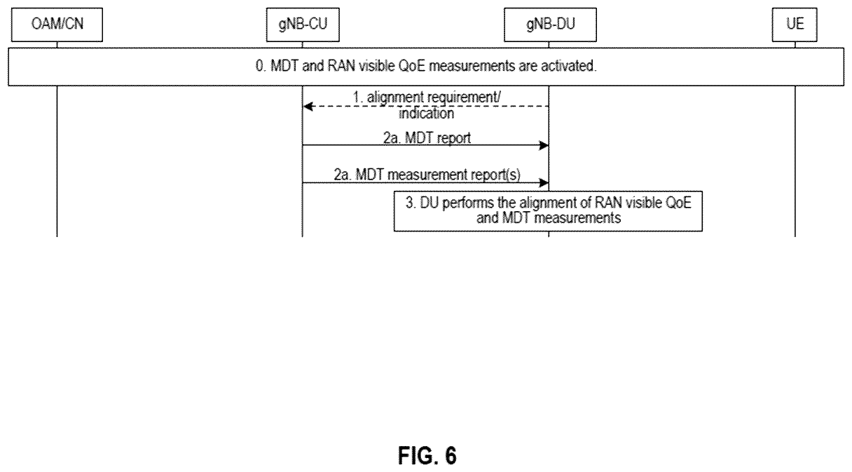

FIG. 6 illustrates a sequence diagram for alignment of radio access network (RAN) visible quality of experience (QoE) and minimized drive test (MDT). In a split architecture, a first network node of a radio access network (RAN) (e.g., distributed unit (DU)) may perform the alignment of RAN visible QoE and MDT.

In step 0, MDT measurement(s) and RAN visible QoE measurement(s) can be activated. The MDT and RAN visible QoE measurements may not be necessarily to be activated simultaneously. The MDT measurement(s) may be activated before the RAN visible QoE, later than the RAN visible QoE measurement(s), or at the same time with the RAN visible QoE measurement(s). The MN/SN may collect MDT measurement report(s) and RAN visible QoE measurement report(s) based on a MDT configuration and a RAN visible QoE measurement configuration. The RAN visible QoE reports can be reported from a UE. A QoE measurement/determination may involve gathering numerous parameters (e.g., encoding, transport, content, type of terminal, network, services infrastructure, media encoding, and/or user's expectations). QoE can be an important metric for design of systems and engineering processes. The information in the RAN visible QoE report may include at least one of: a trace identifier (id) associated with the at least one MDT measurement, an id of the at least one QoE measurement, an id of at least one QoE measurement to be utilized by an entity other than the RAN (e.g., QoE measurement that can be invisible to (or not for utilization by) the RAN), at least one QoE metrics to include in the at least one QoE measurement, at least one QoE values to be determined from the at least one QoE metrics, an indication of one or more nodes (e.g., a MN or a SN) of the RAN that is to utilize the at least one QoE measurement, time stamp information of the at least one QoE measurement, quality of service (QOS) flow information of the at least one QoE measurement, or data radio bearer (DRB) list information of the at least one QoE measurement. The time stamp information of the at least one QoE measurement may include values that contain both date and time parts (e.g., yyyy-mm-dd hh:mm:ss).

In step 1 (optional), a gNB-DU may send alignment requirements to a gNB-CU via a F1AP message (e.g., gNB-DU configuration update) to notify the gNB-CU that the gNB-DU is to perform the alignment of RAN visible QoE and MDT.

In step 2a, if there is MDT report(s) collected in the gNB-CU, the gNB-CU may send the MDT measurement report(s) to the gNB-DU via an F1AP message.

In step 2b, if there is RAN visible QoE measurement report(s) collected in the gNB-CU, the gNB-CU may send the RAN visible QoE measurement report(s) to the gNB-DU via an F1AP message.

In step 3, the gNB-DU may perform a correlation of MDT reports/measurement/results and RAN visible QoE reports/measurement/results according to the measurement id information and/or the time stamp information in the reports. The analysis results can be used to assist with the network optimization.

It should be understood that one or more features from the above implementation examples are not exclusive to the specific implementation examples, but can be combined in any manner (e.g., in any priority and/or order, concurrently or otherwise).

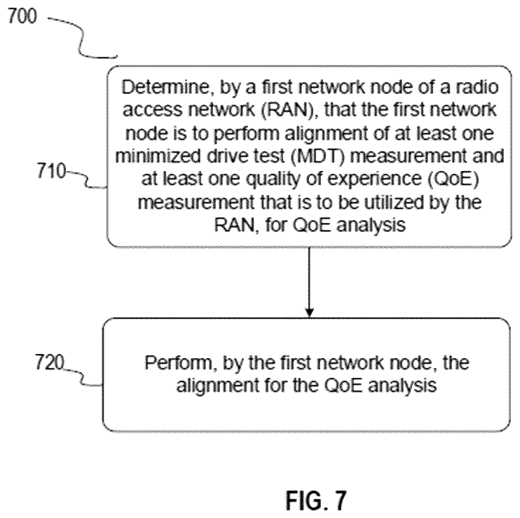

FIG. 7 illustrates a flow diagram of a method 700 for alignment of radio access network (RAN) visible quality of experience (QoE) and minimized drive test (MDT) measurements/reports/results. The method 700 may be implemented using any one or more of the components and devices detailed herein in conjunction with FIGS. 1-2. In overview, the method 700 may be performed by a first network node of a RAN, in some embodiments. Additional, fewer, or different operations may be performed in the method 700 depending on the embodiment. At least one aspect of the operations is directed to a system, method, apparatus, or a computer-readable medium.

A first network node (e.g., a master node (MN) or a secondary node (SN)) of a radio access network (RAN) may determine that the first network node is to perform alignment of at least one minimized drive test (MDT) measurement and at least one quality of experience (QoE) measurement that is to be utilized by the RAN (e.g., a RAN visible QoE configuration), for QoE analysis. The first network node may perform the alignment for the QoE analysis.

In some embodiments, a wireless communication device may generate a report according to the at least one QoE measurement. The report may comprise at least one of: a trace identifier (id) associated with the at least one MDT measurement, an id of the at least one QoE measurement, an id of at least one QoE measurement to be utilized by an entity other than the RAN (e.g., QoE measurement that can be invisible to (or not for utilization by) the RAN), at least one QoE metrics to include in the at least one QoE measurement, at least one QoE values to be determined from the at least one QoE metrics, an indication of one or more nodes (e.g., a MN or a SN) of the RAN that is to utilize the at least one QoE measurement, time stamp information of the at least one QoE measurement, quality of service (QOS) flow information of the at least one QoE measurement, or data radio bearer (DRB) list information of the at least one QoE measurement.

In some embodiments, the first network node (e.g., a MN or a SN) may receive a report of the at least one MDT measurement from a second network node of the RAN. The first network node may receive a report of the at least one QoE measurement from a second network node of the RAN. The second network node may receive an indication that the first network node is to perform the alignment from a core network (CN) or an operations, administration and maintenance (OAM) function. The second network node may send the indication to the first network node. The first network node may determine that the first network node is to perform the alignment for the QoE analysis according to the indication.

In some embodiments, the first network node may receive an indication that the first network node is to perform the alignment from a core network (CN) or an operations, administration and maintenance (OAM) function. The first network node may send the indication to the second network node. The second network node may determine that the first network node is to perform the alignment for the QoE analysis according to the indication.

In some embodiments, the first network node may send a message via XnAP, requesting or indicating that the first network node is to perform the alignment to a second network node of the RAN. In response to the message, the second network node may send an acknowledgment or confirmation to the first network node (via an XnAP message). In certain embodiments, the first network node may comprise a master node (MN); and the second network node may comprise a secondary node (SN). In certain embodiments, the first network node may comprise a secondary node (SN); and the second network node may comprise a master node (MN).

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A method comprising:
determining, by a first network node of a radio access network (RAN), that the first network node is to perform alignment of at least one minimized drive test (MDT) measurement and at least one quality of experience (QoE) measurement that is to be utilized by the RAN, for QoE analysis; and
performing, by the first network node, the alignment for the QoE analysis.

2. The method of claim 1, wherein a wireless communication device generates a report according to the at least one QoE measurement,
wherein the report comprises at least one of:
a trace identifier (id) associated with the at least one MDT measurement,
an id of the at least one QoE measurement,
an id of at least one QoE measurement to be utilized by an entity other than the RAN,
an indication of at least one QoE metrics to include in the at least one QoE measurement,
an indication of at least one QoE values to be determined from the at least one QoE metrics,
an indication of one or more nodes of the RAN that is to utilize the at least one QoE measurement,
time stamp information of the at least one QoE measurement,
quality of service (QOS) flow information of the at least one QoE measurement, or
data radio bearer (DRB) list information of the at least one QoE measurement.

3. The method of claim 1, comprising:
receiving, by the first network node from a second network node of the RAN, a report of the at least one MDT measurement.

4. The method of claim 1, comprising:
receiving, by the first network node from a second network node of the RAN, a report of the at least one QoE measurement.

5. The method of claim 1, wherein the second network node receives, from a core network (CN) or an operations, administration and maintenance (OAM) function, an indication that the first network node is to perform the alignment.

6. The method of claim 5, wherein the second network node sends the indication to the first network node.

7. The method of claim 6, comprising:
determining, by the first network node according to the indication, that the first network node is to perform the alignment for the QoE analysis.

8. The method of claim 1, comprising:
receiving, by the first network node from a core network (CN) or an operations, administration and maintenance (OAM) function, an indication that the first network node is to perform the alignment.

9. The method of claim 8, comprising:
sending, by the first network node, the indication to the second network node.

10. The method of claim 9, wherein the second network node determines, according to the indication, that the first network node is to perform the alignment for the QoE analysis.

11. The method of claim 1, the method comprising:
sending, by the first network node to a second network node of the RAN, a message via XnAP, requesting or indicating that the first network node is to perform the alignment.

12. The method of claim 11, wherein in response to the message, the second network node sends an acknowledgment or confirmation to the first network node.

13. The method of claim 1, wherein the first network node comprises a master node (MN), and the second network node comprises a secondary node (SN).

14. The method of claim 1, wherein the first network node comprises a secondary node (SN), and the second network node comprises a master node (MN).

15. A first network node of a radio access network (RAN). comprising:
at least one processor configured to:
determine that the first network node is to perform alignment of at least one minimized drive test (MDT) measurement and at least one quality of experience (QoE) measurement that is to be utilized by the RAN, for QoE analysis; and
perform the alignment for the QoE analysis.

16. The first network node of claim 15, wherein a wireless communication device generates a report according to the at least one QoE measurement,
wherein the report comprises at least one of:
a trace identifier (id) associated with the at least one MDT measurement,
an id of the at least one QoE measurement,
an id of at least one QoE measurement to be utilized by an entity other than the RAN,
an indication of at least one QoE metrics to include in the at least one QoE measurement,
an indication of at least one QoE values to be determined from the at least one QoE metrics,
an indication of one or more nodes of the RAN that is to utilize the at least one QoE measurement,
time stamp information of the at least one QoE measurement,
quality of service (QOS) flow information of the at least one QoE measurement, or
data radio bearer (DRB) list information of the at least one QoE measurement.

17. The first network node of claim 15, wherein the at least one processor is configured to:
receive, via a receiver from a second network node of the RAN, a report of the at least one MDT measurement.

18. The first network node of claim 15, wherein the at least one processor is configured to:
receive, via a receiver from a second network node of the RAN, a report of the at least one QoE measurement.

19. The first network node of claim 15, wherein the second network node receives, from a core network (CN) or an operations, administration and maintenance (OAM) function, an indication that the first network node is to perform the alignment.

20. The first network node of claim 19, wherein the second network node sends the indication to the first network node.
